(19) United States
(12) Patent Application Publication
(10) Pub. No.: US 2018/0297383 A1
(43) Pub. Date: Oct. 18, 2018

(54) POWERING A POWER MONITOR

(71) Applicant: HEWLETT-PACKARD DEVELOPMENT COMPANY, L.P., Houston, TX (US)

(72) Inventor: David E. Smith, Boise, ID (US)

(73) Assignee: HEWLETT-PACKARD DEVELOPMENT COMPANY, L.P., Houston, TX (US)

(21) Appl. No.: 15/570,933

(22) PCT Filed: Jul. 15, 2015
(86) PCT No.: PCT/US15/40594

§ 371 Date: Oct. 31, 2017

(51) Int. Cl. B41J 29/38; G05F 1/46

(52) U.S. Cl. CPC B41J 29/38; G05F 1/46

(57) ABSTRACT

A power supply circuit for powering a power monitor includes an X type capacitor to isolate low voltage from alternating current (AC) mains, a Schottky diode to generate a direct current (DC) output voltage from the low voltage, and a low dropout regulator to regulate the DC output voltage for powering the power monitor, the power monitor to protect a printer pen of a printer during AC voltage sags.

### BACKGROUND

Printers provide a user with a physical representation of a document by printing a digital representation of a document onto a print medium. The printer, such as a dimensional (2D) printer, includes a number of printer pens used to eject printing fluid or other printable material onto the print medium to form an image. The 2D printer may use a dryer with heater elements to dry the printing fluid on the print medium. Further, the printer may be a 3 dimensional (3D) printer. The 3D printer uses printer pens to print on a bed of build material to print a 3D object.

### BRIEF DESCRIPTION OF THE DRAWINGS

The accompanying drawings illustrate various examples of the principles described herein and are a part of the specification. The examples do not limit the scope of the claims.

FIG. 1A is a diagram of a printer, according to one example of principles described herein.

FIG. 1B is a diagram of a printer, according to one example of principles described herein.

FIG. 2 is a diagram of a power supply circuit for powering a power monitor, according to one example of principles described herein.

FIG. 3A is a graph of an input voltage for alternating current (AC) mains of a power supply circuit, according to one example of principles described herein.

FIG. 3B is a graph of a square wave across a Zener diode of a power supply circuit, according to one example of principles described herein.

FIG. 3C is a graph of a waveform of a direct current (DC) output voltage at a Schottky diode of a power supply circuit, according to one example of principles described herein.

FIG. 4 is a graph of a DC output voltage of a power supply circuit for a number of frequencies, according to one example of principles described herein.

FIG. 5 is a flowchart a method for powering a power monitor, according to one example of principles described herein.

Throughout the drawings, identical reference numbers designate similar, but not necessarily identical, elements.

### DETAILED DESCRIPTION

As mentioned above, printers provide a user with a physical representation of a document by printing a digital representation of a document onto a print medium. To meet print quality and product throughput, printers utilize dryers with heater elements powered directly from alternating current (AC) mains. Often, the heater element's current interacts with the AC mains and cause AC voltage sag. If the AC voltage sag is large enough it will shut down the printer's direct current (DC) power supply leading to failure of the printer pens. To avoid shut down of the printer's DC power supply leading to failure of the printer pens, a power monitor of the printer maintains AC voltage above a threshold that causes DC power supply shutdown.

To power the power monitor, a transformer or a switch mode regulator may be used to generate the low voltage needed by the power monitor. Further, the transformer may operate over the worldwide range of AC mains voltages and frequencies. However, a transformer or a switch mode adds a significant cost to the printer. This results in the costs being passing on to the consumer at time of purchase of the printer.

The principles described herein include a power supply circuit for powering a power monitor. Such a power supply circuit includes an X type capacitor to isolate low voltage from AC mains, a Schottky diode to generate a DC output voltage from the low voltage, and a low dropout regulator to regulate the DC output voltage for the power monitor, the power monitor to protect a printer pen of a printer during AC voltage sags. Such a power supply circuit generates a DC power supply for the power monitor at minimal cost. Further, the power supply circuit operates over a wide range of voltages and frequencies of the AC mains.

In the present specification and in the appended claims, the term “AC mains” means a voltage source that powers a power supply circuit for powering a power monitor. The voltage and frequency of the AC mains varies depending on the geographical location that the power supply circuit operates in.

In the present specification and in the appended claims, the term “X type capacitor” means a circuit element that provides power and various protective measures to the power supply circuit. The protective measures provided by the X type capacitor may include allowing the power supply circuit to connect to a voltage source. This is due to the design of the X type capacitor. The X type capacitor may be made of ceramic discs or metalized self-healing film made of paper, polyester, or polypropylene encased in a flame retardant case.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

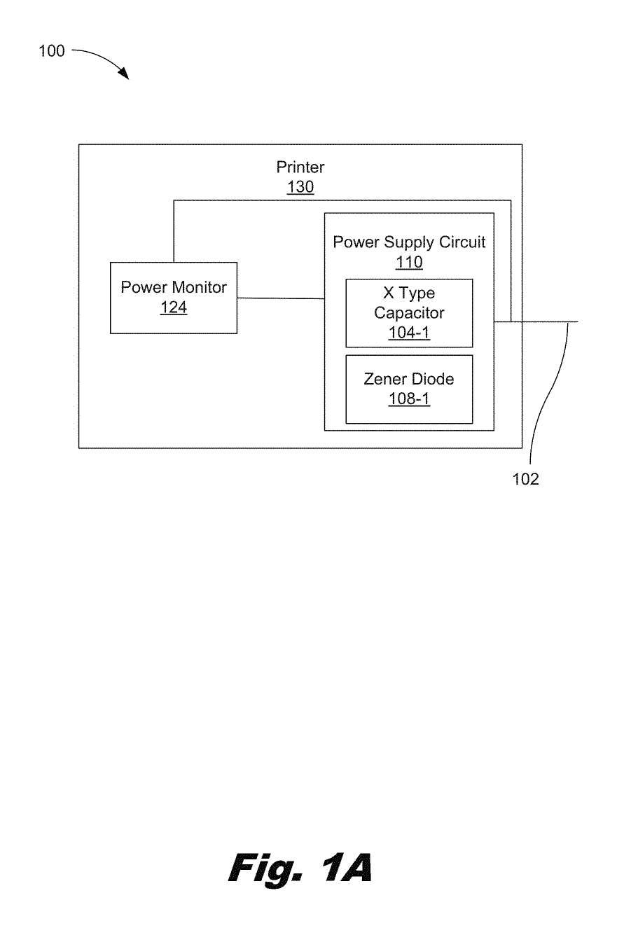

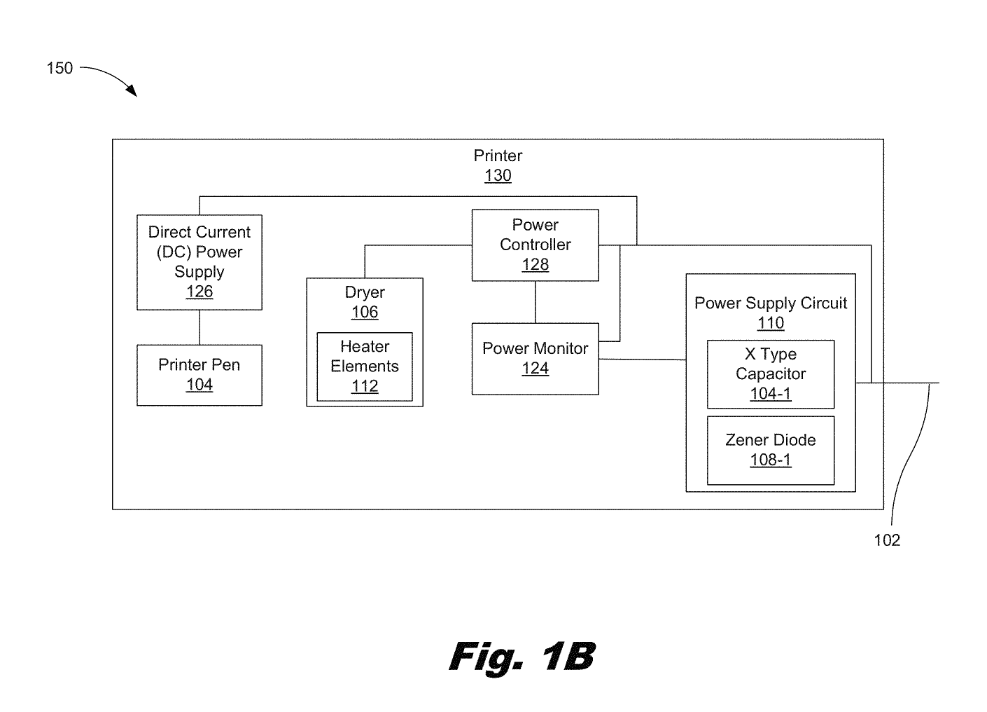

Referring now to the figures, FIG. 1A is a diagram of a printer, according to one example of principles described herein. As will be described below, a printer includes a power supply circuit for powering a power monitor. The power supply circuit includes an X type capacitor to isolate low voltage from AC mains and a Zener diode to act as a regulator diode.

As illustrated, the system (100) includes a printer (130). As will be described in other parts of this specification, the printer (130) provides a user with a physical representation of a document by printing a digital representation of a document onto a print medium. As will be illustrated in FIG. 1B, the printer (130) may include a number of electronic components. The printer may be a 2 dimensional (2D) printer or a 3 dimensional (3D) printer. More information about the printer (130) will be described in other parts of this specification.

Further, the printer (130) includes a power supply circuit (110) As will be described below, the power supply circuit (110) is used for powering a power monitor (124). The power monitor (124) protects a printer pen of the printer (130) during AC voltage sags. As illustrated, the power supply circuit (100) includes an X type capacitor (104-1). The X type capacitor (104-1) isolates low voltage from AC mains (102). The power supply circuit (100) further includes a Zener diode (108-1). The Zener diode (108-1) acts as a regulator diode. Such a power supply circuit generates a DC power supply for the power monitor (124) at minimal cost. More information about the power supply circuit (110) will be described in other parts of this specification

FIG. 1B is a diagram of a printer, according to one example of principles described herein. As will be described below, a printer includes a power supply circuit for powering a power monitor. The power supply circuit includes an X type capacitor to isolate low voltage from AC mains and a Zener diode to act as a regulator diode. The printer further includes a printer pen and includes a dryer with heater elements.

As illustrated, the system (150) includes a printer (130). The printer (130) provides a user with a physical representation of a document by printing a digital representation of a document onto a print medium. The printer includes a DC power supply (126). The DC power supply (126) is connected to a printer pen (104). Further, the DC power supply (126) powers the printer pen (104). In an example, the printer pen (104) is used to eject printing fluid or other printable material onto the print medium to form an image. The drops of printing fluid deposited onto the print medium are dried using a dryer (106) and heater elements (112).

Further, the printer (130) includes AC mains (102). The AC mains (102) may be a voltage source that powers a power supply circuit (110). Further, the AC mains (102) may power the DC power supply (126). The voltage and frequency of the AC mains (102) varies depending on the geographical location that the power supply circuit operates in. For example, in one country, the voltage of the AC mains (102) may operate at 100 volts (V). In another country, the voltage of the AC mains (102) may operate at 240 V. Further, in one country the frequency of the AC mains (102) may operate at 60 hertz (Hz). However, in another country the frequency of the AC mains (102) may operate at 50 Hz.

Further, the printer (130) may include the power supply circuit (110). As mentioned above, the power supply circuit (110) includes X type capacitor (104-1). Further, the X type capacitor (104-1) operates directly across the AC mains (102) of the power supply circuit (110) for powering the power monitor (124). Further, the power supply circuit (110) includes a Zener diode (108-1). As will be described in other parts of this specification, the Zener diode (108-1) may act as a regulator diode for the power supply circuit (110). Further, the power supply circuit (110) may be used to convert the AC voltage of the AC mains (102) to a DC output voltage to power a power monitor (124). Such a power supply circuit generates a DC power supply for the power monitor (124) at minimal cost. Further, the power supply circuit (110) operates over a wide range of voltages and frequencies produced by the AC mains (102). As will be described in other parts of this specification, the power monitor (124) protects the printer pen (104) of the printer (130) during AC voltage sags.

Further, the power monitor (124) may be connected to the AC mains (102) and a power controller (128). In one example, information from the power monitor (124) is used by the power controller (128) to control AC power to the heater elements (112) to avoid AC voltage sags that shutdown the DC power supply (126). More information about the power supply circuit (110) will be described in other parts of this specification.

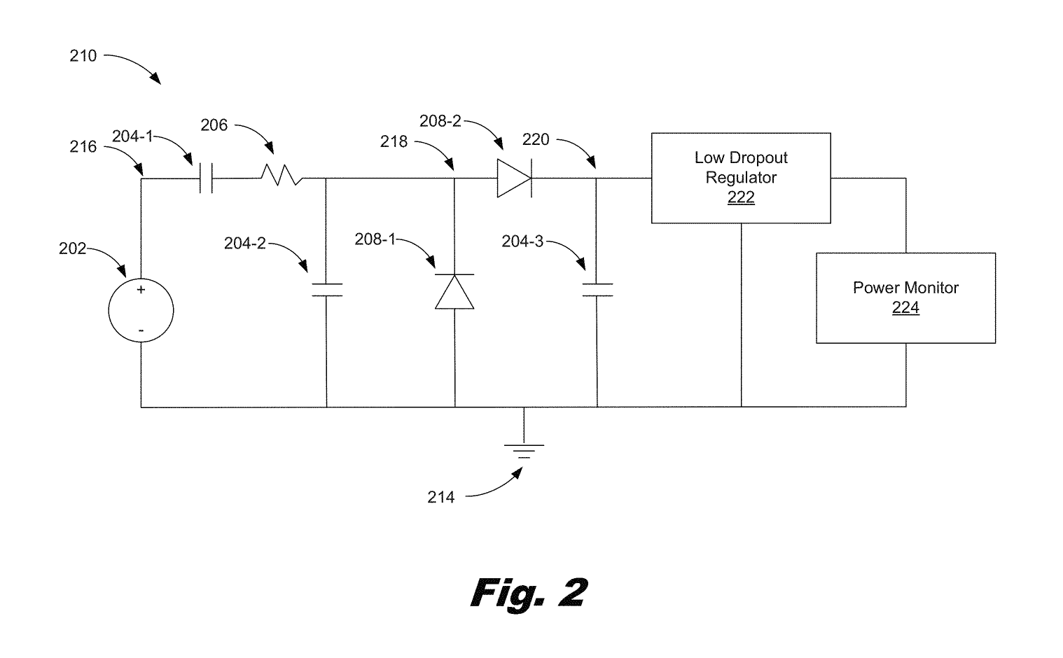

FIG. 2 is a diagram of a power supply circuit for powering a power monitor, according to one example of principles described herein. As will be described below, a power supply circuit is used for powering a power monitor. The power supply circuit may include an X type capacitor to isolate low voltage from AC mains, a Schottky diode to generate a DC output voltage from the low voltage, a low dropout regulator to regulate the DC output voltage for powering the power monitor, the power monitor to protect a printer pen of a printer during AC voltage sags. Further, the power supply circuit may include a number of other circuit elements.

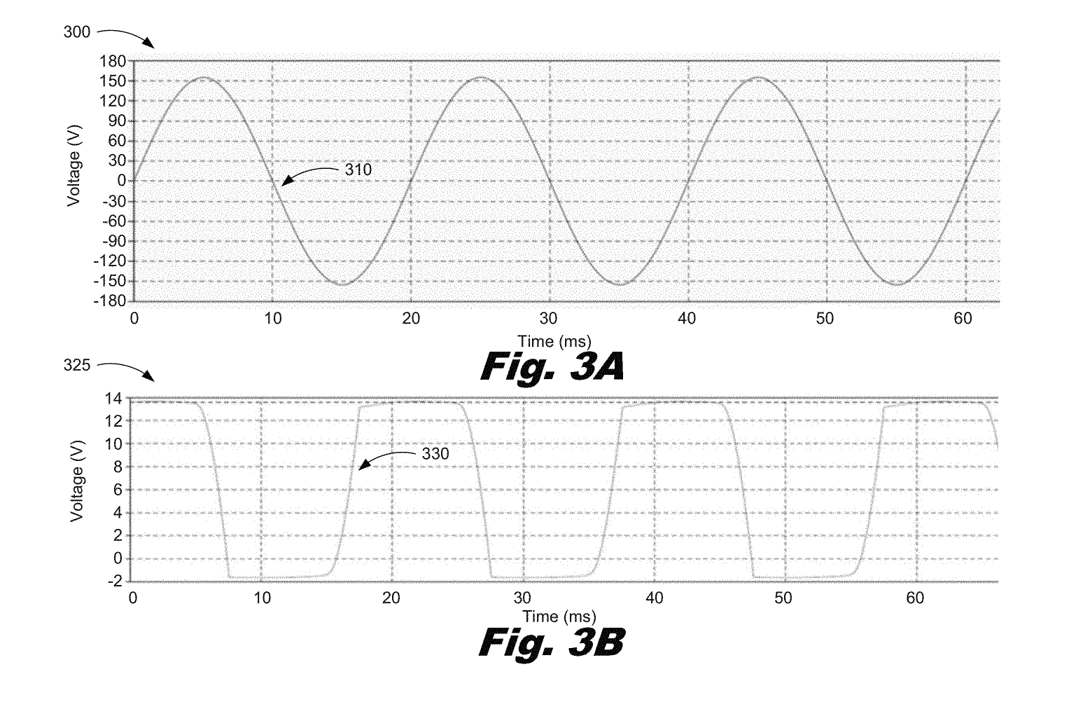

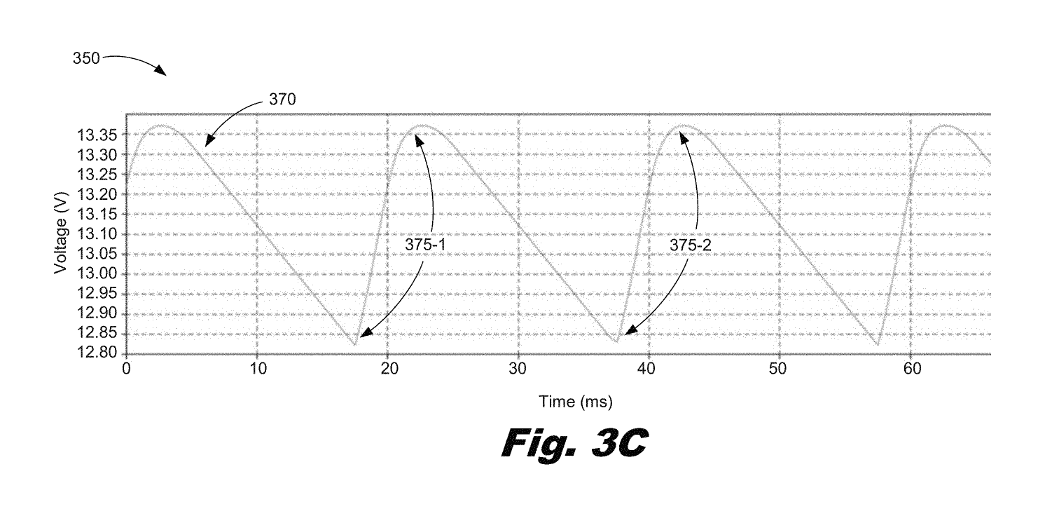

As illustrated, the power supply circuit (210) includes a power source (202). In some examples the power source may be an AC power source. Further, the power source (202) may provide an input voltage to the AC mains (216) of the power supply circuit (210). As mentioned above, the voltage and frequency of the AC mains (216) varies depending on the geographical location that the power supply circuit (210) operates in. As will be described in other parts of this specification, the power source (202) may be 110 V. The 110 V may be a root mean square (RMS) voltage. Further, the power source (202) may operate at 50 Hz. As a result, the AC mains (216) operate at 110 V and 50 Hz. A graph of an input voltage for AC mains (216) of the power supply circuit (210) will be illustrated and described in reference to FIG. 3A.

Further, the power supply circuit (210) includes an X type capacitor (204-1). The X type capacitor (204-1) is a circuit element that provides power and various protective measures to the power supply circuit (210). The X type capacitor (204-1) may be made of ceramic discs or metalized self-healing film made of paper, polyester, or polypropylene encased in a flame retardant case. The X type capacitor (204-1) may be a 0.68 microfarad (uF) capacitor.

As illustrated, the X type capacitor (204-1) operates directly across the AC mains (216) of the power supply circuit (210). The X type capacitor (204-1) isolates low voltage from the AC Mains (216) and absorbs most of the voltage drop to produce a square wave across a Zener diode (208-1). As a result, a single low cost X type capacitor is used to replace an expensive transformer or switch mode circuitry,

Further, the X type capacitor (204-1) is connected from a line side of the AC mains (216) to a resistor (206). In some examples the resistor (206) may be 100 Ohms. In some examples, the X type capacitor (204-1) couples noise to the power supply circuit (210). As a result, the resistor (206) may be used to suppress the noise,

The power supply circuit (210) further includes a bypass capacitor (204-2). As mentioned above, the X type capacitor (204-1) couples noise to the power supply circuit (210). To suppress the noise, the bypass capacitor (204-2) shorts AC signals to ground (214) such that any AC noise on the AC mains (216) that may be present on a DC signal is minimized. As a result, the DC signal is pure. As will be described below, a DC signal, such as a DC output voltage, is produce by a Schottky diode (208-2).

Further, the power supply circuit (210) includes the Zener diode (208-1). The Zener diode (208-1) may be connected to ground (214), the bypass capacitor (204-2), the resistor (206), and the Schottky diode (208-2). The Zener diode (208-1) may have a voltage reverse standoff of 14 V. Further, the Zener diode (208-1) may have a breakdown voltage of 13.3 volts. The Zener diode (208-1) may have one unidirectional channel. In some examples, the Zener diode (208-1) acts a regulator diode to clamp the low voltage between 14 volts (V) and −0.7 V. A waveform at a node (218) of the Zener diode (208-1) will be illustrated and described in FIG. 3B.

As illustrated, the power supply circuit (210) includes a Schottky diode (208-2). The input of the Schottky diode (208-2) may be connected to the resistor (206), the X type capacitor (204-2), the bypass capacitor (204-2), and the Zener diode (208-1). Further, the output of the Schottky diode (208-2) is connected to a filter capacitor (204-3) and a low dropout regulator (222). As mentioned above, the X type capacitor (204-2) produces a square wave across the Zener diode (208-1) of the power supply circuit (210). The positive portion of the square wave is coupled through the Schottky diode (208-2) to the filter capacitor (204-3) of the power supply circuit (210). The Schottky diode generates a DC output voltage from the low voltage.

The resulting DC output voltage provides DC voltage to the low dropout regulator (222) that powers a power monitor (224). In some examples, the DC output voltage at the Schottky diode (208-2) is an average of 13.1 V. A graph of a waveform at node (220) will be illustrated and described in FIG. 3C.

Further, the power supply circuit (210) includes the low dropout regulator (222). The low dropout regulator (222) is a DC linear voltage regulator. A DC linear voltage regulator is used to maintain a steady DC voltage. In some examples, the low dropout regulator (222) is a 12 V low dropout regulator. As a result, the DC output voltage at the Schottky diode (208-2) of 13.1 V is regulated to 12 V by the low dropout regulator (222).

Further, the power monitor (224) may be connected to the power supply circuit (210). The power monitor (224) may be powered by the low dropout regulator (222). To avoid shut down of the printer's DC power supply leading to failure of the printer pens, the power monitor (224) of the printer maintains AC voltage above a threshold that causes DC power supply shutdown. As a result, the power monitor (224) protects the printer pen of the printer during AC voltage sags by keeping the DC power supply for the printer pens alive during AC voltage sags. This may include providing DC power as needed to the printer pens. As mentioned above, information from the power monitor is used by a power controller to control AC power to heater elements of a printer to avoid AC voltage sags that shutdown the DC power supply. In some examples, the power monitor (224) includes voltage monitoring. In other examples, the power monitor (224) includes current monitoring. In yet another example, the power monitor (224) includes both voltage monitoring and current monitoring. As a result, the power monitor (224) protects the printer pen of the printer during AC voltage sags by monitoring voltage and/or current.

While this example has been described with reference to the power supply circuit producing 12 V for powering the power monitor, the power supply circuit may be modified to produce a voltage appropriate for powering other types of power monitors. As a result, the power supply circuit may produce voltages such as 6 V, 18 V, 24 V, or other voltages needed to power other power monitors.

FIG. 3A is a graph of an input voltage for AC mains of a power supply circuit, according to one example of principles described herein. As will be described below, the input voltage may alternate between 150 V and −150 V.

As illustrated, the graph (300) may include an x-axis. The x-axis may be in terms of time, such as milliseconds (ms). Further, the x-axis may range from 0 ms to 60 ms. Further, the input voltage (310) may repeat every 20 ms.

The graph (300) may further include a y-axis. The y-axis may be in terms of voltage. Further, the y-axis may range from −180 V to 180 V. As illustrated, the input voltage (310) may alternate between 150 V and −150 V. As a result, the AC mains voltage is 110 V RMS at 50 Hz.

FIG. 3B is a graph of a square wave across a Zener diode of a power supply circuit, according to one example of principles described herein. As mentioned above, the X type capacitor produces a square wave across a Zener diode of the power supply circuit.

As illustrated, the graph (325) may include an x-axis. The x-axis may be in terms of time, such as ms. Further, the x-axis may range from 0 ms to 60 ms. Further, the square wave (330) may repeat every 20 ms.

Further, the graph (325) may include a y-axis. The y-axis may be in terms of voltage. The y-axis may range from −2 V to 14 V. As illustrated, the square wave (330) shows that the voltage across the Zener diode alternates between −1.6 V and +13.7 V.

Further, the square wave (330) of FIG. 3B may be 90 degrees out of phase from the input voltage (310) of FIG. 3A. This is due to the X type capacitor of the power supply circuit being a reactive circuit component. As a result, power is transferred to the power supply circuit on an upswing of the input voltage (310).

FIG. 3C is a graph of a DC output voltage at a Schottky diode of a power supply circuit, according to one example of principles described herein, As mentioned above, a positive portion of the square wave is coupled through a Schottky diode to a lifter capacitor of the power supply circuit to produce a DC output voltage.

As illustrated, the graph (350) may include an x-axis. The x-axis may be in terms of time, such as ms. Further, the x-axis may range from 0 ms to 60 ms. Further, the DC output voltage (370) may repeat every 20 ms.

Further, the graph (350) may include a y-axis. The y-axis may be in terms of voltage. The y-axis may range from 12.80 V to 13.35. As illustrated, due to the voltage drop across the Schottky diode, the DC output voltage (370) alternates between 12.80 V and 13.35 V. This produces an average of 13.1 V. As mentioned above, the 13.1 V is used to power a low dropout regulator.

As illustrated, the DC output voltage (370) includes ripples (375-1, 375-2). In some example, the ripples (375-1, 375-2) may be undesirable and lead to unwanted operation of the power supply circuit. The low dropout regulator of the power supply circuit may be used to remove the ripples (375-1, 375-2). As a result, the low dropout regulator of the power supply circuit may produce a steady DC voltage of 12 V.

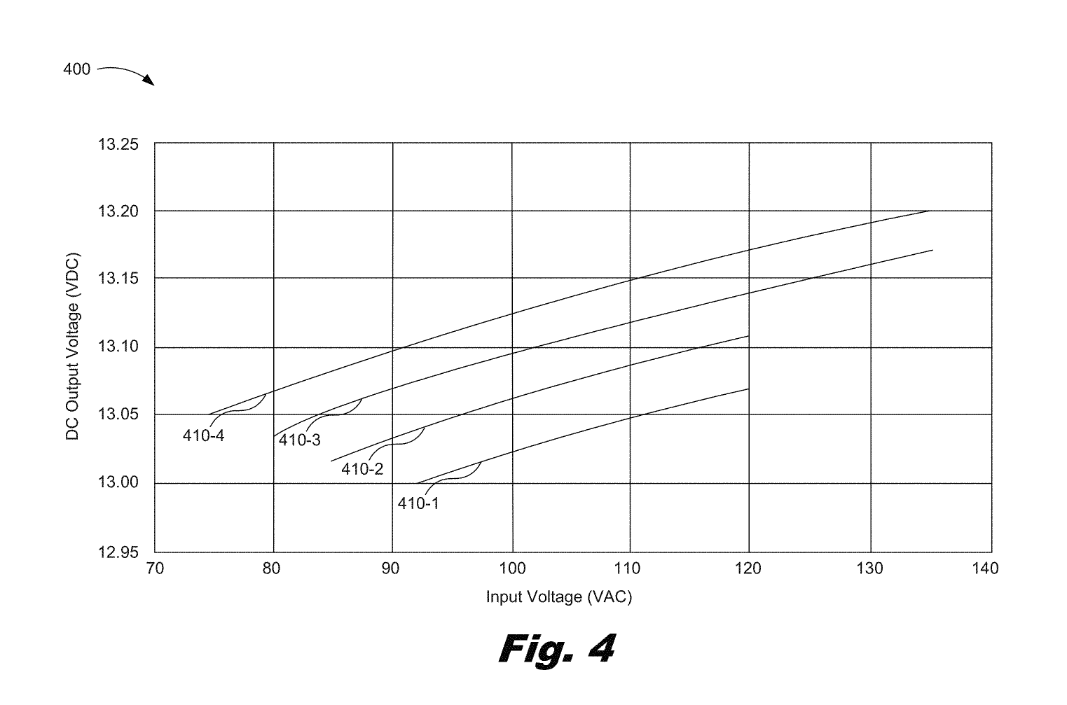

FIG. 4 is a graph of a DC output voltage of a power supply circuit for a number of frequencies, according to one example of principles described herein. As will be described below, the DC output voltage provided to the power monitor may be dependent on voltage and frequency of AC mains,

As illustrated, the graph (400) may include an x-axis. The x-axis may be in terms of an input voltage such as alternating current voltage (VAC). Further, the x-axis may range from 70 VAC to 140 VAC.

Further, the graph (400) may include a y-axis for DC output voltage. The Y-axis may be in terms of a direct current voltage (VDC). As illustrated, the Y-axis may range from 12.95 VDC to 13.25 VDC.

The graph (400) further includes a number of DC output voltages (410). For example, the graph (400) may include DC output voltage one (410-1), DC output voltage two (410-2), DC output voltage three (410-3), and DC output voltage four (410-4). DC output voltage one (410-1) may be a DC output voltage when the input voltage is operating at 45 Hz. DC output voltage two (410-2) may be a DC output voltage when the input voltage is operating at 50 Hz. DC output voltage three (410-3) may be a DC output voltage when the input voltage is operating at 55 Hz. DC output voltage four (410-4) may be a DC output voltage when the input voltage is operating at 60 Hz.

As illustrated, as the VAC increases, the VDC increases. As the frequency increases the VDC increases. As a result, if the VAC and the frequency is too low, the low dropout regulator may drop out of regulation.

Further, the DC load current on the power supply circuit, due to the power monitor is 3.5 milliamps. As illustrated, the graph (400) illustrates sensitivity not only to AC Mains voltage but also frequency. However, the variance in DC output voltage is relatively small. This variance is minimized by using the low dropout regulator that provides 12 V to the printer pen.

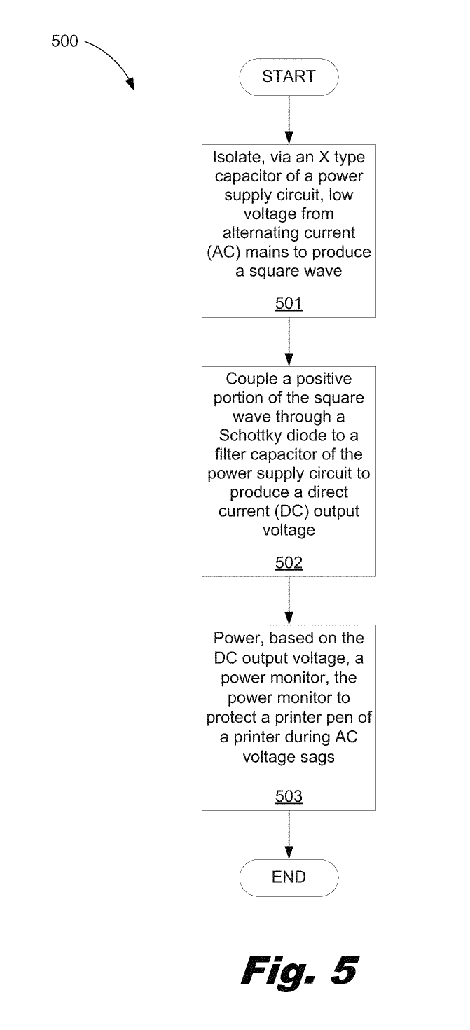

FIG. 5 is a flowchart a method for powering a power monitor, according to one example of principles described herein. In one example, the method (500) may be executed by the power supply circuit (110) of FIGS. 1A or 1B. In other examples, the method (500) may be executed by the power supply circuit (210) of FIG. 2. In this example, the method (500) includes isolating (501), via an X type capacitor of a power supply circuit, low voltage from AC mains to produce a square wave, coupling (502) a positive portion of the square wave through a Schottky diode to a filter capacitor of the power supply circuit to produce a DC output voltage, and powering (503), based on the DC output voltage, a power monitor, the power monitor to protect a printer pen of a printer during AC voltage sags.

The method (500) includes isolating (501), via an X type capacitor of a power supply circuit, low voltage from AC mains to produce a square wave. The square wave may be produced across a Zener diode of the power supply circuit.

As mentioned above, the method (500) includes coupling (502) a positive portion of the square wave through a Schottky diode to a filter capacitor of the power supply circuit to produce a DC output voltage. The DC output voltage provides power to a low dropout regulator of the power supply circuit.

As mentioned above, the method (500) includes powering (503), based on the DC output voltage, a power monitor, the power monitor protect a printer pen of a printer during AC voltage sags. The low dropout regulator regulates the DC output voltage to power the power monitor. The dropout regulator regulates the DC output voltage to 12 V.

The preceding description has been presented to illustrate and describe examples of the principles described. This description is not intended to be exhaustive or to limit these principles to any precise form disclosed. Many modifications and variations are possible in light of the above teaching. For example, blocks of a flowchart of may be placed in an order different than what is depicted in the drawings,

What is claimed is:

1. A power supply circuit for powering a power monitor, the power supply circuit comprising:
an X type capacitor to isolate low voltage from alternating current (AC) mains;
a Schottky diode to generate a direct current (DC) output voltage from the low voltage; and
a low dropout regulator to regulate the DC output voltage for powering the power monitor, the power monitor to protect a printer pen of a printer during AC voltage sags.

2. The power supply circuit of claim 1, wherein the X type capacitor operates directly across the AC mains of the power supply circuit.

3. The power supply circuit of claim 1, wherein the X type capacitor produces a square wave across a Zener diode of the power supply circuit, the Zener diode alternating between −1.6 volts (V) and 13.7 V.

4. The power supply circuit of claim 3, wherein a positive portion of the square wave is coupled through the Schottky diode to a filter capacitor of the power supply circuit.

5. The power supply circuit of claim 1, wherein the DC output voltage at the Schottky diode is an average of 13.1 volts (V).

6. The power supply circuit of claim 1, wherein the low dropout regulator maintains 12 volts (V) for powering the power monitor.

7. A printer, the printer comprising:
a power supply circuit for powering a power monitor, the power supply circuit comprising:
an X type capacitor to isolate low voltage from alternating current (AC) mains; and
a Zener diode to act as a regulator diode.

8. The printer of claim 7, wherein the X type capacitor operates directly across the AC mains of the power supply circuit.

9. The printer of claim 7, wherein the X type capacitor produces a square wave across the Zener diode of the power supply circuit, the Zener diode alternating between −1.6 volts (V) and 13.7 V.

10. The printer of claim 9, wherein a positive portion of the square wave is coupled through a Schottky diode to a filter capacitor of the power supply circuit.

11. The printer of claim 9, wherein a DC output voltage at the Schottky diode is an average of 13.1 volts (V) to power a low dropout regulator of the power supply circuit.

12. A method for powering a power monitor, the method comprising:
isolating, via an X type capacitor of a power supply circuit, low voltage from alternating current (AC) mains to produce a square wave;
coupling a positive portion of the square wave through a Schottky diode to a filter capacitor of the power supply circuit to produce a direct current (DC) output voltage; and
powering, based on the DC output voltage, the power monitor, the power monitor to protect a printer pen of a printer during AC voltage sags.

13. The method of claim 12, wherein isolating, via the X type capacitor of the power supply circuit, the low voltage from the AC mains produces the square wave across a Zener diode of the power supply circuit.

14. The method of claim 12, wherein the DC output voltage provides power to a low dropout regulator of the power supply circuit.

15. The method of claim 14, wherein the low dropout regulator regulates the DC output voltage to power the power monitor,
